(19) United States
(12) Patent Application Publication
(10) Pub. No.: US 2026/0318228 A1
(43) Pub. Date: Oct. 15, 2026

(54) INTEGRATED POWER GENERATION SYSTEM FOR ACHIEVING ZERO CARBON EMISSION

(71) Applicant: XI'AN THERMAL POWER RESEARCH INSTITUTE CO., LTD., Xi'an (CN)

(72) Inventors: Zongtai LI, Xi'an (CN); Zhichao WANG, Xi'an (CN); Zhonghua JIN, Xi'an (CN); Fan FANG, Xi'an (CN); Zixiu JIA, Xi'an (CN); Xiangyu ZHANG, Xi'an (CN); Xiaolei JING, Xi'an (CN); Bo ZHANG, Xi'an (CN); Xiaofeng XIANG, Xi'an (CN); Chen ZHAO, Xi'an (CN); Runmin LIU, Xi'an (CN)

(73) Assignee: XI'AN THERMAL POWER RESEARCH INSTITUTE CO., LTD., Xi'an (CN)

(21) Appl. No.: 19/365,296

(22) Filed: Oct. 22, 2025

(30) Foreign Application Priority Data
Apr. 14, 2025 (CN) 202510459537.2

(51) Int. Cl. F01K 11/02; B01D 53/62; F01K 23/06

(52) U.S. Cl. CPC F01K 11/02; B01D 53/62; F01K 23/06; B01D 2257/504; B01D 2258/0283

(57) ABSTRACT

An integrated power generation system for achieving zero carbon emission, including: a renewable power generation unit, a green fuel production device, a thermal power unit, and a carbon capture device, wherein the renewable power generation unit is configured to generate electricity by using renewable energy; the renewable power generation unit is connected to the green fuel production device; the renewable power generation unit is configured to supply electrical energy to the green fuel production device; the green fuel production device is configured to produce green fuel; the green fuel production device is connected to the thermal power unit; the thermal power unit is configured to generate electricity by using the green fuel and fossil fuel; part of the carbon capture device is connected to the thermal power unit; and the carbon capture device is configured to capture carbon dioxide from flue gas discharged by the thermal power unit.

### TECHNICAL FIELD

Embodiments of the present disclosure belong to the technical field of power generation, in particular to an integrated power generation system for achieving zero carbon emission.

### BACKGROUND

Traditional power generation systems use fossil fuel as their primary fuel. After combustion, the fossil fuel will produce a large amount of carbon dioxide. Large-scale emission of carbon dioxide, which is a greenhouse gas, will lead to global warming. Therefore, there is an urgent need for a power generation system that reduces carbon emission.

### SUMMARY OF THE INVENTION

The embodiments of the present disclosure aim to solve at least one of the technical problems existing in the prior art, and provide an integrated power generation system for achieving zero carbon emission.

Embodiments of a first aspect of the present disclosure provide an integrated power generation system for achieving zero carbon emission, including: a renewable power generation unit configured to generate electricity by using renewable energy;
a green fuel production device, wherein the renewable power generation unit is connected to the green fuel production device; the renewable power generation unit is configured to supply electrical energy to the green fuel production device; the green fuel production device is configured to produce green fuel, and the green fuel does not contain carbon element;
a thermal power unit, wherein the green fuel production device is connected to the thermal power unit, and the thermal power unit is configured to generate electricity by using the green fuel and fossil fuel;
a carbon capture device connected to the thermal power unit, wherein the carbon capture device includes a CCUS (Carbon Capture, Utilization and Storage) device and a DAC (Direct Air Capture) device; the CCUS device is configured to capture carbon dioxide from flue gas discharged by the thermal power unit; the DAC device is configured to capture carbon dioxide from the air; a total amount of carbon dioxide captured by the CCUS device and the DAC device is equal to an amount of carbon dioxide produced by burning the fossil fuel by the thermal power unit.

In some embodiments of the present disclosure, the green fuel production device is at least one of a hydrogen production device and an ammonia production device.

In some embodiments of the present disclosure, the integrated power generation system for achieving zero carbon emission further includes:
a biomass supply device, wherein the biomass supply device is connected to the thermal power unit, and is configured to supply biomass fuel to the thermal power unit.

In some embodiments of the present disclosure, the integrated power generation system for achieving zero carbon emission further includes:
a zero-carbon fuel storage device, wherein the zero-carbon fuel storage device is connected to the green fuel production device; the zero-carbon fuel storage device is connected to the biomass supply device; the zero-carbon fuel storage device is connected to the thermal power unit; and the zero-carbon fuel storage device is configured to supply the biomass fuel and the green fuel to the thermal power unit.

In some embodiments of the present disclosure, the carbon capture device includes:
a carbon capture container connected to the thermal power unit, wherein the carbon capture container is configured to hold the flue gas discharged from the thermal power unit; the CCUS device is in communication with the carbon capture container; the CCUS device is configured to capture carbon dioxide in the carbon capture container; the DAC device is arranged outside the carbon capture container, and is close to an exhaust port of the carbon capture container; and the carbon dioxide captured by the DAC device comes from the carbon dioxide in the gas discharged from the carbon capture container and the carbon dioxide in the atmosphere.

In some embodiments of the present disclosure, the carbon capture device further includes a carbon dioxide storage device, wherein the carbon dioxide storage device is connected to the CCUS device; and the carbon dioxide storage device is connected to the DAC device.

In some embodiments of the present disclosure, the renewable power generation unit is connected to the CCUS device; the renewable power generation unit is connected to the DAC device; and the renewable power generation unit is configured to supply electrical energy to the CCUS device and the DAC device.

In some embodiments of the present disclosure, the thermal power unit includes:
a boiler, wherein a fuel inlet of the boiler is in communication with the green fuel production device; and an exhaust port of the boiler is in communication with the carbon capture device;
a steam turbine, wherein the boiler is connected to the steam turbine; and a generator, wherein the steam turbine is connected to the generator; and the generator is connected to a power grid.

In some embodiments of the present disclosure, the thermal power unit further includes:
a heat storage device, wherein the heat storage device is connected to at least one of the power grid, the renewable power generation unit, and the generator; the heat storage device is connected to the steam turbine; and the heat storage device is configured to store electrical energy from at least one of the power grid, the renewable power generation unit, and the generator in a form of thermal energy.

In some embodiments of the present disclosure, the thermal power unit further includes:
a fossil fuel supply device, wherein the fossil fuel supply device is connected to the boiler and is configured to supply the fossil fuel to the boiler.

The integrated power generation system for achieving zero carbon emission according to the embodiments of the present disclosure includes a renewable power generation unit, a green fuel production device, a thermal power unit, and a carbon capture device, wherein the renewable power generation unit is configured to generate electricity by using renewable energy; the renewable power generation unit is connected to the green fuel production device; and the renewable power generation unit is configured to supply electrical energy to the green fuel production device, so as to green the power supply of the green fuel production device and prevent carbon emission. The green fuel production device is directly or indirectly connected to the boiler of the thermal power unit. The green fuel production device is configured to supply green energy such as hydrogen and ammonia to the thermal power unit. Green fuel such as hydrogen and ammonia contains no carbon element, and no carbon is emitted when the green fuel is burned in the thermal power unit, thereby achieving zero carbon emission from the combustion of the green fuel. The thermal power unit is further configured to achieve a power generation function by burning the fossil fuel. The thermal power unit is connected to the carbon capture device. The fossil fuel containing carbon element is burned in the thermal power unit to produce carbon-containing flue gas; and the carbon-containing flue gas is discharged from the thermal power unit and enters the carbon capture device, so as to capture carbon dioxide in the flue gas through carbon capture. In addition, the carbon capture device also captures carbon dioxide in the air. By capturing carbon dioxide in the flue gas and carbon dioxide in the air through the carbon capture device, an amount of carbon dioxide captured by the carbon capture device is equal to an amount of carbon dioxide produced by the combustion of the fossil fuel, that is, zero carbon emission of the zero-carbon power generation system is achieved.

In addition, the integrated power generation system for achieving zero carbon emission in this embodiment can also achieve peak shaving and frequency regulation, reduce the impact of the renewable power generation unit on the power grid, maintain the stability of the power grid, and ensure the safety of electricity consumption.

### BRIEF DESCRIPTION OF THE DRAWINGS

FIG. 1 is a schematic diagram of an integrated power generation system for achieving zero carbon emission according to the first embodiment of the present disclosure.

Reference numerals in the accompanying drawings:
100. integrated power generation system for achieving zero carbon emission;
10. renewable power generation unit;
20. green fuel production device;
30. thermal power unit; 31. boiler; 32. steam turbine; 33. generator; 34. fossil fuel supply device; 35. heat storage device;
40. carbon capture device; 41. carbon capture container; 42. CCUS device; 43. DAC device; 44. carbon dioxide storage device;
50. biomass supply device;
60. zero-carbon fuel storage device;
70. power grid.

### DETAILED DESCRIPTION OF THE EMBODIMENTS

Exemplary embodiments of the present disclosure will be described in more detail below with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to facilitate a more thorough understanding of the present disclosure and to fully convey the scope of the present disclosure to those skilled in the art.

It should be understood that the terms used herein are merely for the purpose of describing specific exemplary embodiments and are not intended to be limiting. Unless the context clearly dictates otherwise, the singular forms “a”, “an”, and “the” as used herein may also include the plural forms. The terms “comprise”, “comprising”, “include”, and “having” are inclusive and thus specify the presence of stated features, steps, operations, elements, and/or components, but do not preclude the presence or addition of one or more other features, steps, operations, elements, components, and/or combinations thereof. The steps, processes, and operations of the control method described herein are not to be construed as necessarily requiring their performance in a specific order described or illustrated, unless an order of performance is explicitly stated. It should also be understood that additional or alternative steps may be used.

Although the terms “first”, “second”, “third” and the like may be used herein to describe various elements, components, regions, layers, and/or sections, these elements, components, regions, layers, and/or sections should not be limited by these terms. These terms may be used only to distinguish one element, component, region, layer, or section from another region, layer, or section. Unless the context clearly indicates otherwise, terms such as “first”, “second” and other numerical terms used herein do not imply a sequence or order. Therefore, a first element, component, region, layer, or section discussed below may be referred to as a second element, component, region, layer, or section without departing from the teachings of the exemplary embodiments.

For ease of description, spatial relative relationship terms can be used in the text to describe the relationship of one element or feature shown in the figure relative to another element or feature. These relative relationship terms are, for example, “inside”, “outside”, “inner side”, “outer side”, “below”, “beneath”, “above”, “over”, etc. Such spatial relative relationship terms are intended to include different orientations of the device in use or operation other than the orientation depicted in the figure. For example, if the device in the figure is turned over, elements described as “below” or “beneath” other elements or features will then be oriented as “above” or “over” the other elements or features. Therefore, the exemplary term “beneath” can include both the above and below orientations. The device can be otherwise oriented (rotated by 90 degrees or in other directions) and the spatial relative relationship descriptors used in the text are interpreted accordingly.

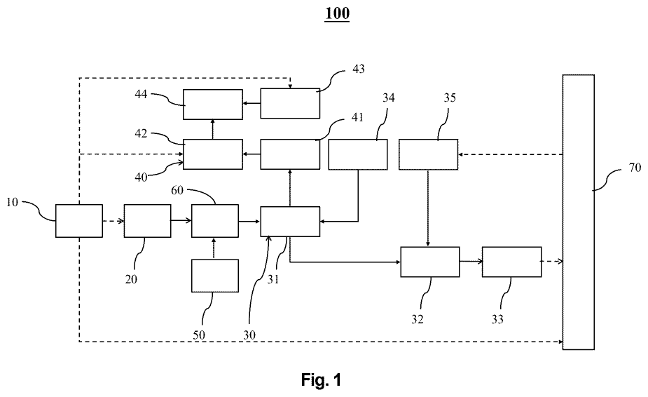

As shown in FIG. 1, the present disclosure provides an integrated power generation system 100 for achieving zero carbon emission, and the integrated power generation system 100 includes: a renewable power generation unit 10, a green fuel production device 20, a thermal power unit 30, and a carbon capture device 40, wherein the renewable power generation unit 10 is configured to generate electricity by using renewable energy; the renewable power generation unit 10 is connected to the green fuel production device 20, and the renewable power generation unit 10 is configured to supply electrical energy to the green fuel production device 20. The green fuel production device 20 is configured to produce green fuel; the green fuel production device 20 is connected to the thermal power unit 30; the thermal power unit 30 is configured to generate electricity by using the green fuel and fossil fuel; and the carbon capture device 40 is connected to the thermal power unit 30, and the carbon capture device 40 is configured to capture carbon dioxide from the flue gas discharged by the thermal power unit 30 and carbon dioxide in the atmosphere.

The integrated power generation system 100 for achieving zero carbon emission according to the embodiments of the present disclosure includes a renewable power generation unit 10, a green fuel production device 20, a thermal power unit 30, and a carbon capture device 40, wherein the renewable power generation unit 10 is configured to generate electricity by using renewable energy; the renewable power generation unit 10 is connected to the green fuel production device 20; and the renewable power generation unit 10 is configured to supply electrical energy to the green fuel production device 20, so as to green the power supply of the green fuel production device 20 and prevent carbon emission. The green fuel production device 20 is directly or indirectly connected to the boiler 31 of the thermal power unit 30. The green fuel production device 20 is configured to supply green energy such as hydrogen and ammonia to the thermal power unit 30. Green fuel such as hydrogen and ammonia contains no carbon element, and no carbon is emitted when the green fuel is burned in the thermal power unit 30, thereby achieving zero carbon emission from the combustion of the green fuel. The thermal power unit 30 is further configured to achieve a power generation function by burning the fossil fuel. The thermal power unit 30 is connected to the carbon capture device 40. The fossil fuel containing carbon element is burned in the thermal power unit 30 to produce carbon-containing flue gas; and the carbon-containing flue gas is discharged from the thermal power unit 30 and enters the carbon capture device 40, so as to capture carbon dioxide in the flue gas through carbon capture. In addition, the carbon capture device 40 also captures carbon dioxide in the air. By capturing carbon dioxide in the flue gas and carbon dioxide in the air through the carbon capture device 40, an amount of carbon dioxide captured by the carbon capture device 40 is equal to an amount of carbon dioxide produced by the combustion of the fossil fuel, that is, zero carbon emission of the zero-carbon power generation system is achieved. In addition, the renewable power generation unit 10 is configured to supply electricity to the green fuel production device 20, further reduce the impact of unstable power generation of the renewable power generation unit 10 on the power grid, and improve the stability of the power grid.

The renewable power generation unit 10 in this embodiment can adopt solar power generation, wind power generation, hydroelectric power generation, geothermal power generation, etc. The renewable power generation unit 10 does not produce carbon emission during the power generation process, thereby ensuring zero carbon emission of the zero-carbon power generation system.

In some embodiments of the present disclosure, the green fuel production device 20 is a hydrogen production device, the green fuel production device 20 is an ammonia production device, or the green fuel production device 20 includes a hydrogen production device and an ammonia production device. Green hydrogen fuel or green ammonia fuel is produced through the green fuel production device 20, so as to realize the green fuel production of the green fuel production device 20. It should be noted that the hydrogen fuel produced by the green fuel production device 20 in this embodiment does not contain carbon element, and the ammonia fuel produced by the green fuel production device 20 does not contain carbon element, so as to ensure that no carbon dioxide will be produced when the hydrogen fuel or ammonia fuel is burned in the thermal power unit 30, and achieve zero emission during combustion of the green fuel.

The hydrogen production device in this embodiment can be an electrolytic water hydrogen production device, a photocatalytic decomposition device, a biological fermentation device, a thermochemical cycle hydrogen production device, etc. The ammonia production device in this embodiment can be an electrochemical ammonia synthesis device, a photocatalytic ammonia synthesis device, a biological nitrogen fixation device, etc. The carbon emission of the hydrogen production device in this embodiment during the hydrogen production process is zero, and the carbon emission of the ammonia production device in this embodiment during the ammonia production process is zero, so as to ensure that the green fuel production device 20 will not produce carbon emission during the process of producing green fuel.

In some embodiments of the present disclosure, the integrated power generation system 100 for achieving zero carbon emission further includes: a biomass supply device 50, wherein the biomass supply device 50 is directly or indirectly connected to the boiler 31 of the thermal power unit 30, and the biomass supply device 50 is configured to supply biomass fuel to the thermal power unit 30. Specifically, the biomass supply device 50 is directly connected to the boiler 31 of the thermal power unit 30; and the biomass supply device 50 transports the biomass fuel into the boiler 31 of the thermal power unit 30 for combustion. During the combustion process of the biomass fuel, a certain amount of carbon will be emitted. However, since plants used to produce the biomass fuel absorb or fix a certain amount of carbon from the atmosphere during their growth process, after the biomass fuel is burned, all the carbon the biomass fuel has absorbed or fixed is released and emitted into the atmosphere, that is, the carbon emitted by combustion of the biomass fuel is the carbon absorbed or fixed during the raw material generation process, which means that the combustion of the biomass fuel does not generate additional carbon emission. Zero carbon emission is achieved by using the combustion of biomass fuel. Specifically, the biomass fuel refers to organic substances formed through photosynthesis, including plants, animals and their wastes, etc. By adjusting the amount of biomass fuel transported from the biomass supply device 50 to the thermal power unit 30 and the amount of green fuel transported from the green fuel production device 20 to the thermal power unit 30, the zero-carbon power generation system can meet the requirements of peak shaving and frequency regulation.

In some embodiments of the present disclosure, the integrated power generation system 100 for achieving zero carbon emission further includes: a zero-carbon fuel storage device 60, wherein the zero-carbon fuel storage device 60 is connected to the green fuel production device 20; the zero-carbon fuel storage device 60 is connected to the biomass supply device 50; the zero-carbon fuel storage device 60 is connected to the thermal power unit 30; and the zero-carbon fuel storage device 60 is configured to supply the biomass fuel and green fuel to the thermal power unit 30. The green fuel produced by the green fuel production device 20 is stored through the zero-carbon fuel storage device 60, and the biomass fuel is stored through the zero-carbon fuel storage device 60, such that the green fuel and the biomass fuel are stored and mixed in the zero-carbon fuel storage device 60. According to the demand characteristics of the zero-carbon power generation system, the amount of zero-carbon fuel input from the zero-carbon fuel storage device 60 to the boiler 31 of the thermal power unit 30 is adjusted, such that the zero-carbon power generation system meets the requirements of peak shaving and frequency regulation.

In some embodiments of the present disclosure, the thermal power unit 30 includes: a boiler 31, wherein a fuel inlet of the boiler 31 is in direct or indirect communication with the green fuel production device 20. The green fuel produced by the green fuel production device 20 is directly input into the boiler 31 or input into the boiler 31 through the zero-carbon fuel storage device 60. When the green fuel is burned in the boiler 31, no carbon is emitted, that is, when the green fuel produced by the green fuel production device 20 is burned in the boiler 31, zero carbon emission is achieved. The fuel inlet of the boiler 31 is directly or indirectly connected to the biomass supply device 50. The biomass fuel is directly transported from the biomass supply device 50 into the boiler, or the biomass fuel is transported from the biomass supply device 50 to the zero-carbon fuel storage device 60 and then transported from the zero-carbon fuel storage device 60 to the boiler 31, such that the biomass fuel is burned in the boiler 31 to achieve zero carbon emission.

The exhaust port of the boiler 31 is in communication with the carbon capture device 40; the carbon dioxide in the flue gas discharged from the boiler 31 is captured through the CCUS device 42 and the DAC device 43 of the carbon capture device 40; most of the carbon dioxide in the flue gas is captured by the CCUS device 42 and then discharged into the air; and the carbon dioxide in the air is captured through the DAC device 43 of the carbon capture device 40, such that an amount of carbon dioxide captured by the CCUS device 42 and the DAC device 43 of the carbon capture device 40 is equal to an amount of carbon dioxide produced by the combustion of fossil fuel, and the amount of carbon dioxide captured by the zero-carbon power generation system is balanced with the amount of carbon dioxide generated, thereby achieving zero carbon emission of the power generation system in this embodiment.

In this embodiment, the CCUS (Carbon Capture, Utilization and Storage) device 42 is an integrated device of a series of technologies, aiming to reduce the emission of carbon dioxide in the flue gas into the atmosphere, and mitigate the impact of climate change. The DAC (Direct Air Capture) device 43 usually refers to a device that directly captures carbon dioxide from the atmosphere.

The thermal power unit 30 further includes a steam turbine 32 and a generator 33, wherein the boiler 31 is connected to the steam turbine 32; the steam turbine 32 is connected to the generator 33; and the generator 33 is connected to a power grid 70. The high-temperature and high-pressure steam generated by the combustion in the boiler 31 is transported inside the steam turbine 32; the steam turbine 32 converts the energy of the high-temperature and high-pressure steam into mechanical energy; the mechanical energy of the steam turbine 32 enables the generator 33 to do work; and the generator 33 converts the mechanical energy into electrical energy and transports the electrical energy to the power grid 70.

In some embodiments of the present disclosure, the thermal power unit 30 further includes: a fossil fuel supply device 34, wherein the fossil fuel supply device 34 is connected to the boiler 31 and is configured to supply the fossil fuel to the boiler 31. Since biomass fuel, hydrogen fuel, and ammonia fuel are more difficult to obtain compared with fossil fuel, in order to ensure normal operation of the thermal power unit 30, the thermal power unit 30 also adopts fossil fuel as fuel, that is, the thermal power unit 30 can use fossil fuel and green fuel as fuel, or the thermal power unit 30 uses fossil fuel, green fuel, and biomass fuel as fuel. The flue gas generated by the combustion of the fossil fuel in the boiler 31 contains carbon dioxide; and the carbon dioxide in the flue gas is captured twice by the carbon capture device 40, so as to ensure that all the carbon dioxide generated by the combustion of the fossil fuel is captured by the carbon capture device 40, and achieve zero carbon emission of the power generation system in this embodiment.

In some embodiments of the present disclosure, the thermal power unit 30 further includes: a heat storage device 35, wherein the heat storage device 35 is connected to at least one of the power grid 70, the renewable power generation unit 10, and the generator 33; the heat storage device 35 is connected to the steam turbine 32; and the heat storage device 35 is configured to store electrical energy from at least one of the power grid 70, the renewable power generation unit 10, and the generator 33 in a form of thermal energy. When the demand of the user for electrical energy is low, the power grid 70 transports part of the electricity to the heat storage device 35, and the heat storage device 35 stores the electrical energy in a form of thermal energy. When the demand of the user for electrical energy is high, the heat storage device 35 releases the thermal energy to the steam turbine 32; the steam turbine 32 converts the heat released by the heat storage device 35 into mechanical energy; and the mechanical energy is finally transported to the generator 33 and converted into electrical energy, and is then transported to the power grid 70. In addition, the heat storage device 35 can also store electrical energy when an on-grid price of the renewable power generation unit 10 and the electricity price of the power grid 70 are at low levels, and convert back into electrical energy when the demand on a user side is high (the electricity price is high).

In some embodiments of the present disclosure, the carbon capture device 40 includes: a carbon capture container 41, a CCUS device 42, and a DAC device 43. Specifically, the carbon capture container 41 is connected to an exhaust port of the boiler 31 of the thermal power unit 30; the carbon capture container 41 is configured to hold the flue gas discharged from the thermal power unit 30; the CCUS device 42 is in communication with the carbon capture container 41 and is configured to capture the carbon dioxide in the carbon capture container 41. The DAC device 43 is arranged outside the carbon capture container 41 and is arranged close to the exhaust port of the carbon capture container 41; and the DAC device 43 is configured to capture the carbon dioxide discharged from the carbon capture container 41 into the air. The exhaust port of the boiler 31 of the thermal power unit 30 discharges the flue gas generated by combustion; and the flue gas enters the carbon capture container 41; the CCUS device 42 in communication with the carbon capture container 41 captures the carbon dioxide in the flue gas to reduce the carbon dioxide content in the flue gas in the carbon capture container 41. The flue gas in the carbon capture container 41 is discharged into the air through the exhaust port of the carbon capture container 41. The DAC device 43 arranged near the exhaust port of the carbon capture container 41 captures the carbon dioxide discharged from the carbon capture container 41 into the air, so as to reduce the carbon dioxide content in the flue gas discharged from the carbon capture container 41. The carbon dioxide in the flue gas discharged from the thermal power unit 30 is captured for the first time by the CCUS device 42. After most of the carbon dioxide in the flue gas is captured by the CCUS device 42, the carbon dioxide is discharged from the carbon capture container 41 and then discharged into the air via the exhaust port of the carbon capture container 41. Then, the carbon dioxide in the air near the exhaust port of the carbon capture container 41 is captured for the second time by the DAC device 43, such that the amount of carbon dioxide captured by the CCUS device 42 and the DAC device 43 of the carbon capture device 40 is equal to the amount of carbon dioxide generated by the combustion of the fossil fuel, thereby balancing the amount of carbon dioxide captured by the integrated power generation system and the amount of carbon dioxide generated by the integrated power generation system, and further achieving zero emission of carbon dioxide of the integrated power generation system.

In some embodiments of the present disclosure, the carbon capture device 40 further includes a carbon dioxide storage device 44, wherein the carbon dioxide storage device 44 is connected to the CCUS device 42 and the DAC device 43; the CCUS device 42 stores the captured carbon dioxide in the carbon dioxide storage device 44; and the DAC device 43 also stores the captured carbon dioxide in the carbon dioxide storage device 44. The carbon dioxide stored in the carbon dioxide storage device 44 can be used to synthesize chemical raw materials or products such as methanol, formic acid, and urea, so as to improve effective utilization of resources.

In some embodiments of the present disclosure, the renewable power generation unit 10 is connected to the CCUS device 42; and the renewable power generation unit 10 is configured to supply electrical energy to the CCUS device 42. By supplying electrical energy to the CCUS device 42 through the renewable power generation unit 10, zero carbon emission of the power supply device of the CCUS device 42 can be achieved. The renewable power generation unit 10 is connected to the DAC device 43; and the renewable power generation unit 10 is configured to supply electrical energy to the DAC device 43. By supplying electrical energy to the DAC device 43 through the renewable power generation unit 10, zero carbon emission of the power supply device of the DAC device 43 can be achieved, ensuring zero carbon emission of the zero-carbon power generation system.

It can be understood that the above embodiments are merely exemplary embodiments adopted to illustrate the principles of the present disclosure, however, the present disclosure is not limited thereto. For those skilled in the art, various modifications and improvements can be made without departing from the spirit and essence of the present disclosure, and these modifications and improvements are also considered to fall within the protection scope of the present disclosure.

1. An integrated power generation system for achieving zero carbon emission, comprising:
a renewable power generation unit configured to generate electricity by using renewable energy;
a green fuel production device, wherein the renewable power generation unit is connected to the green fuel production device; the renewable power generation unit is configured to supply electrical energy to the green fuel production device; the green fuel production device is configured to produce green fuel, and the green fuel does not contain carbon element;
a thermal power unit, wherein the green fuel production device is connected to the thermal power unit, and the thermal power unit is configured to generate electricity by using the green fuel and fossil fuel;
a carbon capture device connected to the thermal power unit, wherein the carbon capture device comprises a Carbon Capture, Utilization and Storage (CCUS) device and a Direct Air Capture (DAC) device; the CCUS device is configured to capture carbon dioxide from flue gas discharged by the thermal power unit; the DAC device is configured to capture carbon dioxide from the air; a total amount of carbon dioxide captured by the CCUS device and the DAC device is equal to an amount of carbon dioxide produced by burning the fossil fuel by the thermal power unit; and
the carbon capture device comprises: a carbon capture container connected to an exhaust port of the thermal power unit, wherein the carbon capture container is configured to hold the flue gas discharged from the thermal power unit; the CCUS device is in communication with the carbon capture container; and the DAC device is arranged outside the carbon capture container, and is close to an exhaust port of the carbon capture container.

2. The integrated power generation system for achieving zero carbon emission according to claim 1, wherein the green fuel production device is at least one of a hydrogen production device and an ammonia production device.

3. The integrated power generation system for achieving zero carbon emission according to claim 1, wherein the integrated power generation system for achieving zero carbon emission further comprises:
a biomass supply device, wherein the biomass supply device is connected to the thermal power unit, and is configured to supply biomass fuel to the thermal power unit.

4. The integrated power generation system for achieving zero carbon emission according to claim 3, wherein the integrated power generation system for achieving zero carbon emission further comprises:
a zero-carbon fuel storage device, wherein the zero-carbon fuel storage device is connected to the green fuel production device; the zero-carbon fuel storage device is connected to the biomass supply device; the zero-carbon fuel storage device is connected to the thermal power unit; and the zero-carbon fuel storage device is configured to supply the biomass fuel and the green fuel to the thermal power unit.

5. The integrated power generation system for achieving zero carbon emission according to claim 1, wherein the carbon capture device further comprises a carbon dioxide storage device; the carbon dioxide storage device is connected to the CCUS device; and the carbon dioxide storage device is connected to the DAC device.

6. The integrated power generation system for achieving zero carbon emission according to claim 1, wherein the renewable power generation unit is connected to the CCUS device; the renewable power generation unit is connected to the DAC device; and the renewable power generation unit is configured to supply electrical energy to the CCUS device and the DAC device.

7. The integrated power generation system for achieving zero carbon emission according to claim 1, wherein the thermal power unit comprises:
a boiler, wherein a fuel inlet of the boiler is in communication with the green fuel production device; and an exhaust port of the boiler is in communication with the carbon capture device;
a steam turbine, wherein the boiler is connected to the steam turbine; and
a generator, wherein the steam turbine is connected to the generator; and the generator is connected to a power grid.

8. The integrated power generation system for achieving zero carbon emission according to claim 7, wherein the thermal power unit further comprises:
a heat storage device, wherein the heat storage device is connected to at least one of the power grid, the renewable power generation unit, and the generator; the heat storage device is connected to the steam turbine; and the heat storage device is configured to store electrical energy from at least one of the power grid, the renewable power generation unit, and the generator in a form of thermal energy.

9. The integrated power generation system for achieving zero carbon emission according to claim 7, wherein the thermal power unit further comprises:
a fossil fuel supply device, wherein the fossil fuel supply device is connected to the boiler and is configured to supply the fossil fuel to the boiler.
